(19) United States
(12) Patent Application Publication
(10) Pub. No.: US 2025/0094924 A1
(43) Pub. Date: Mar. 20, 2025

(54) SYSTEMS AND METHODS TO RESOLVE CONFLICTS BETWEEN RECORDS OF A COLLABORATION ENVIRONMENT

(71) Applicant: ASANA, INC., San Francisco, CA (US)

(72) Inventors: Shantanu Tulshibagwale, San Francisco, CA (US); Bradley Peter Portnoy, San Francisco, CA (US); Abdulghafar Al Tair, San Francisco, CA (US); Phillips Smith Peter, III, San Francisco, CA (US)

(21) Appl. No.: 17/385,698

(22) Filed: Jul. 26, 2021

(51) Int. Cl. G06Q 10/10; G06F 21/62

(52) U.S. Cl. CPC G06Q 10/103; G06F 21/6209; G06F 2221/2141

(57) ABSTRACT

Systems and methods to resolve conflicts between records of a collaboration environment are described herein. Exemplary implementations may: manage environment state information maintaining a collaboration environment; obtain hierarchical information specifying hierarchies for the work unit records, project records, and/or portfolio records; identify conflicts between individual records by virtue of the individual work units records being subordinate to more than one of the project records; resolve the conflicts; and/or perform other operations.

### FIELD OF THE DISCLOSURE

The present disclosure relates to systems and methods to resolve conflicts between records of a collaboration environment.

### BACKGROUND

Collaboration environments, sometimes referred to as work management platforms, may enable users to assign projects, tasks, or other assignments to assignees (e.g., other users) to complete. A collaboration environment may comprise an environment in which individual users and/or a virtual team of users does its work and may enable users to work in a more organized and efficient manner. Projects may be a way to organize groups of tasks. Portfolios may be a way to organize groups of projects.

### SUMMARY

One aspect of the present disclosure relates to a system configured to resolve conflicts between records of a collaboration environment. The collaboration environment may specify a multi-tiered, hierarchical arrangement of work unit records, project records, portfolio records and/or other items that make up the collaboration environment. For example, a work unit record may be subordinate to a project record. The project record may include one or more work unit records subordinate to the project record because the work records may make up the project record, and/or otherwise support a project defined by the project record. A portfolio record may include one or more project records subordinate to the portfolio record and/or that make up the portfolio record.

Traditionally, settings configured within one or more records may be individually contained within a given record. For example, a given work unit record may have certain settings with respect to access restrictions, presentation of information, and/or other features of the record. A project record containing the work unit record may have one or more different settings that apply to the project record and/or work unit records for units of work contained within the project. A portfolio record containing the project record may have further different settings that apply to the portfolio record, the project record contained within the portfolio record, and/or work unit records for units of work contained within the project. The difference in settings may pose a conflict between which settings should apply to the work unit record, the project record, and/or the portfolio record. These conflicts may be even more present when a given record is specified as being part of more than one record hierarchy, meaning the given record is included in more than one other record (e.g., it is multi-homed).

One or more implementations of the systems and methods presented herein propose a solution to resolve conflicts between records. One or more conflicts may be resolved by determining to apply one or more of the settings while suppressing one or more other ones of the settings. In some implementations, the one or more settings that are applied may be governed by the settings associated with the lowest level of work (e.g., the work unit record) rather than the settings existing at a higher level of work (e.g., the project record, portfolio record, and/or other records). In some implementations, the settings that are applied may be governed by an individual user and/or individual team that is involved as a collaborator(s) of the records. In some implementations, the manner in which conflicts are resolved may be pre-configured to automatically apply certain settings and suppress others. The above examples of implementations of resolving conflicts of administrative settings are not intended to be limiting but merely serve as examples of what the systems and methods presented herein may accomplish in improving the workflow, organization, and/or presentation of information in a collaboration environment.

One or more implementations of a system configured to resolve conflicts between records of a collaboration environment may include one or more hardware processors configured by machine-readable instructions and/or other components. Executing the machine-readable instructions may cause the one or more hardware processors to facilitate conflict resolution between records of a collaboration environment. The machine-readable instructions may include one or more computer program components. The one or more computer program components may include one or more of an environment state component, an organization component, a conflict component, an impact component, a rules component, a resolution component, and/or other components.

The environment state component may be configured to manage environment state information maintaining a collaboration environment and/or other information. The collaboration environment may be configured to facilitate interaction by users with the collaboration environment. The environment state information may include one or more records. The one or more records may include one or more of work unit record, project records, portfolio records, objective records, and/or other records. The work unit records may include work unit information associated with units of work managed, created, and/or assigned within the collaboration environment. The project records may include project information associated with projects managed, created, and/or assigned within the collaboration environment.

In some implementations, the environment state component may be configured to obtain hierarchical information specifying hierarchies for the records. By way of non-limiting illustration, the hierarchical information may specify individual work unit records as subordinate to one or more of the project records. An individual project record may include one or more of the work unit records by virtue of the one or more of the work unit records being subordinate to the individual project record. In some implementations, a first work unit record may be subordinate to one or more of a first project record, a second project record, and/or other records.

The conflict component may be configured to identify conflicts between records. The conflict component may be configured to identify conflicts between the individual work unit records and individual project records by virtue of the individual work unit records being subordinate to more than one of the project records. By way of non-limiting illustration, a first conflict may be identified. The first conflict may be between the first work unit record and the first project record, and the first work unit record and the second project record, by virtue of the first work unit record being subordinate to both the first project record and the second project record.

The resolution component may be configured to resolve the conflicts between the individual work unit records and the individual project records. By way of non-limiting illustration, the resolution component may be configured to resolve the first conflict.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to resolve conflicts between records of a collaboration environment, in accordance with one or more implementations.

FIG. 2 illustrates a method to resolve conflicts between records of a collaboration environment, in accordance with one or more implementations.

FIG. 3 illustrates a user interface, in accordance with one or more implementations.

FIG. 4 illustrates a user interface, in accordance with one or more implementations.

FIG. 5 illustrates a user interface, in accordance with one or more implementations.

FIG. 6 illustrates a user interface, in accordance with one or more implementations.

### DETAILED DESCRIPTION

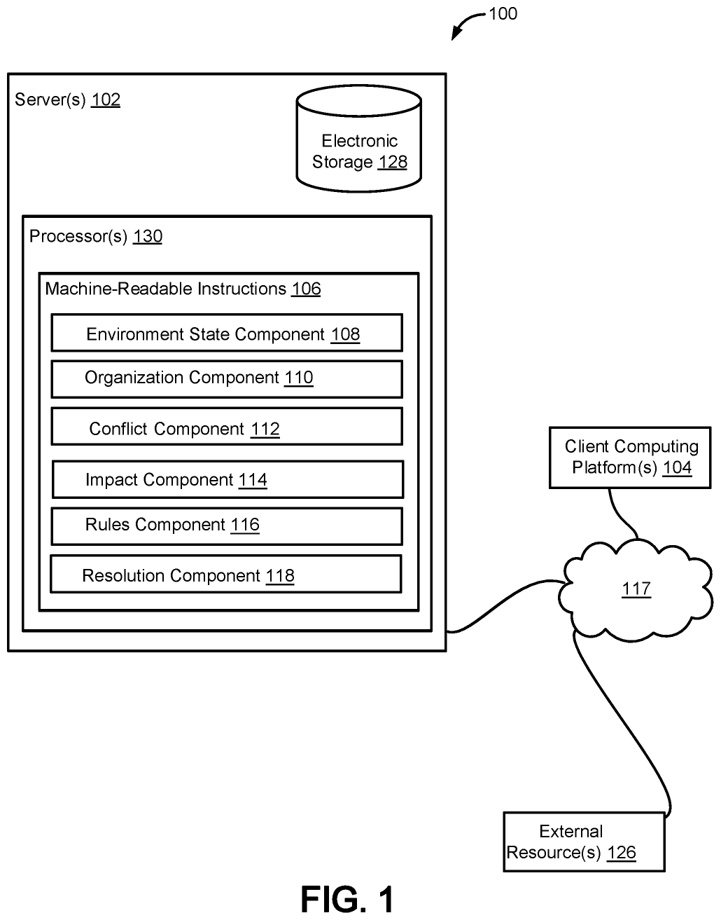

FIG. 1 illustrates a system 100 configured to resolve conflicts between records of a collaboration environment, in accordance with one or more implementations. The collaboration environment may specify a multi-tiered, hierarchical arrangement of work unit records, project records, portfolio records, and/or other records that make up the collaboration environment. Traditionally, settings configured within individual records may be individually contained within a given record. If a record is subordinate to and/or associated with more than one other record, differences in the settings may exist. The differences in the settings may pose conflicts between which settings should be applied.

In some implementations, system 100 may include one or more of one or more servers 102, one or more client computing platforms 104, external resource(s) 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may include one or more of non-transitory electronic storage 128, one or more processors 130 configured by machine-readable instructions 106, and/or other components. The non-transitory electronic storage 128 may store one or more records and/or other information. Machine-readable instructions 106 may include one or more instruction components. The instruction components may include computer program components. Executing the machine-readable instructions 106 may cause server(s) 102 to facilitate nesting of portfolios within a collaboration environment. The computer program components may include one or more of an environment state component 108, an organization component 110, a conflict component 112, an impact component 114, a rules component 116, a resolution component 118, and/or other components.

Environment state component 108 may be configured to manage environment state information and/or other information used in maintaining a collaboration environment. The collaboration environment may be configured to facilitate interaction by users within the collaboration environment. The environment state information may include one or more of user records, work unit records, project records, portfolio records, objective records, and/or other records. The work unit records may include work information comprising values for work unit parameters associated with units of work managed, created, and/or assigned within the collaboration environment. The project records may include project information associated with projects managed, created, and/or assigned within the collaboration environment. The portfolio records including portfolio information associated with portfolios managed within the collaboration environment. The objective records may include objective information associated with business objectives managed, created, and/or owned within the collaboration environment.

The user information in the user records may include values of user parameters. The values of the user parameters may be organized in user records corresponding to users interacting with and/or viewing the collaboration environment. The values of the user parameters may include information describing the users, their actions within the collaboration environment, their settings, and/or other user information; and/or metadata associated with the users, their actions within the environment, their settings, and/or other user information. Individual ones of the users may be associated with individual ones of the user records. A user record may define values of the user parameters associated with a given user.

The values of the user parameters may, by way of non-limiting example, specify one or more of: a user name, a group (or team) parameter, a user account, a user department, descriptive user content, a to-email, a from-email, a photo, an organization, a workspace, one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), one or more notification settings, one or more administrative settings, one or more progress parameters, status information for one or more work units the user is associated with (units of work assigned to the user, assigned to other users by the user, completed by the user, past-due date, and/or other information), progress information for one or more business objectives the user is associated with (business objectives owned by the user, of which the user is a collaborator, fulfilled by the user, past-due date, and/or other information), one or more performance/productivity metrics of a given user (e.g., how many units of work the user has completed, how quickly the user completed the units of work, how quickly the user completes certain types of work units, the efficiency of the user, bandwidth of the user, activity level of the user, how many business objectives the user has helped fulfill through their completion of units of work, etc.), application access information (e.g., username/password for one or more third-party applications), one or more favorites and/or priorities, preference information, and/or other information.

The work information in the work unit records may include values of one or more work unit parameters. The values of the work unit parameters may be organized in work unit records corresponding to units of work managed, created, and/or assigned within the collaboration environment. A given unit of work may have one or more assignees and/or collaborators working on the given work unit. Units of work may include one or more to-do items, action items, and/or other units of work one or more users should accomplish and/or plan on accomplishing. To-do items and/or action items may be things a user does within the collaboration environment and/or outside of the collaboration environment. Units of work may be created by a given user for the given user and/or created by the given user and assigned to one or more other users. Individual units of work may include one or more of an individual task, an individual sub-task, and/or other units of work assigned to and/or associated with one or more users. Individual units of work may include one or more digital content items. An individual unit of work may include an individual digital content item by virtue of the individual digital content item (and/or a copy or instance thereof) being attached and/or appended thereto. A digital content item may include one or more of an image, a video, an audio file, a PDF, a word document, and/or other digital content items.

In some implementations, units of work created by, assigned to, and/or completed by the users may refer generally to a linking of the units of work with the individual users in the collaboration environment. A unit of work may be linked with a user in a manner that defines one or more relationships between the user and the unit of work. Such a relationship may connote and/or be a result of an action (past, present, and/or future) of the user with respect to the unit of work. Such actions may include one or more of creating a work unit record for a unit of work, being assigned to participate in a unit of work, participating in a unit of work, being granted access to a work unit record of a unit of work, adjusting a value of a work unit parameter of a work unit record of a unit of work, and/or other actions.

In some implementations, the one or more work unit parameters may include one or more of a work assignment parameter, a work management parameter, work creation parameter, and/or other parameters. The values of the work assignment parameter may describe units of work assigned to the individual users. The values of the work management parameter may describe units of work managed by the individual users. The values of the work creation parameter may describe units of work created by the individual users.

In some implementations, values of work unit parameters may include one or more of a unit of work name, a unit of work description, one or more unit of work dates (e.g., a start date, a due date or end date, a completion date, and/or dates), role information, a status parameter (e.g., an update, a hardcoded status update, a completed/incomplete/mark complete, a measured status, a progress indicator, quantity of sub-work units remaining for a given unit of work, measure of urgency, and/or other status parameter), one or more user comment parameters (e.g., permission for who may make comments such as an assignee, an assignor, a recipient, one or more followers, and/or one or more other interested parties; content of the comments; one or more times; presence or absence of the functionality of up-votes; one or more hard-coded responses; and/or other parameters), one or more interaction parameters (e.g., indicating a given unit of work is being worked on/was worked on, a given work unit of work was viewed, a given unit of work was selected, how long the given unit of work has been idle, a last interaction parameter indicating when and what user last interacted with the given unit of work, users that interacted with the given unit of work, quantity and/or content of comments on the unit of work, and/or other interaction parameters indicating sources of the interactions, context of the interactions, content of the interactions and/or time for the interactions), one or more digital content item attachments, privacy, an associated URL, one or more interaction parameters (e.g., sources of the interactions, context of the interactions, content of the interactions, time for the interactions, and/or other interaction parameters), updates, ordering of units of work within a given unit of work (e.g., tasks within a project, subtasks within a task, etc.), state of a workspace for a given unit of work (e.g., application state parameters, application status, application interactions, user information, and/or other parameters related to the state of the workspace for a unit of work), one or more performance/productivity metrics for a given unit of work, hierarchical information (see, e.g., organization component 110), settings information (see, e.g., organization component 110), one or more custom fields (e.g., priority, cost, stage, and/or other custom fields), and/or other information.

The values of the work assignment parameter describing units of work assigned to the individual users may be determined based on one or more interactions by one or more users with a collaboration environment. In some implementations, one or more users may create and/or assign one or more unit of work to themselves and/or another user. In some implementations, a user may be assigned a unit of work and the user may effectuate a reassignment of the unit of work from the user or one or more other users.

In some implementations, values of the work assignment parameter may indicate that a status parameter of a unit of work has changed from “incomplete” to “marked complete” and/or “complete”. In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date).

In some implementations, managing by the environment state component 108 include maintaining queues of the units of work assigned to the users. The queues may be presented to the users in a user interface of the collaboration environment to facilitate access to the units of work via work unit pages. A work unit page for a unit of work may comprise a user interface portion and/or dedicated user interface of the collaboration environment from which users access the unit of work. Individual queues may represent the units of work assigned to individual users organized in an order based on the individual end dates and/or other dates (e.g., start dates) and/or other ordering. Individual queues may be presented in a user interface based on one or more of a list view, a calendar view, and/or other views. The calendar view may be a calendar view by week, by more than one week (e.g., 1^{st} through 15^{th}), by month, by more than one month (e.g., May through July), and/or other calendar views. Units of work may be represented in a calendar view by user interface elements (e.g., icons, calendar entries, etc.).

Project information in project records may define values of project parameters for projects managed within the collaboration environment. Projects may be presented to the users via project pages of the collaboration environment to facilitate access to the project. A project page for a project may comprise a user interface portion and/or dedicated user interface of the collaboration environment from which users access the project. An individual project may include an individual set of the units of work. An individual set of units of work of an individual project may be subordinate to the individual project, make up the individual project, and/or otherwise support the individual project. The individual set of units of work may directly facilitate progress toward fulfillment of the individual project. The individual set of units of work may directly contribute to the progress. By way of non-limiting illustration, a connection between the individual set of units of work and a corresponding individual project may be direct in that completion of at least one of the units of work may have a direct impact on progress toward fulfillment of the individual project. The concept of “direct impact” may mean that completion of the at least one unit of work may cause progress toward fulfillment of the individual project based on independent action completed and/or started with respect to the at least one unit of work. Accordingly, completion of an individual set of units of work may indicate that the individual project has been completed and/or fulfilled.

The project parameters may characterize one or more projects managed within the collaboration environment and/or via the collaboration environment, and/or the metadata associated with the one or more projects. Individual ones of the projects may be associated with individual ones of the project records. The project information may define values of the project parameters associated with a given project managed within the collaboration environment and/or via the collaboration environment. A given project may have one or more owners and/or one or more collaborators working on the given project. The given project may include one or more units of work assigned to one or more users under the given project heading. In some implementations, projects may include one or more units of work that may directly facilitate progress toward fulfillment of the projects. Accordingly, completion of the set of units of work may directly contribute to progress toward fulfillment of the project. By way of non-limiting illustration, an individual project may be associated with a client and the units of work under the individual project heading may be work directly contributing to the fulfillment of a business relationship with the client.

The values of the project parameters may, by way of non-limiting example, include one or more of: one or more units of work within the project (which may include values of work unit parameters defined by one or more work unit records), one or more user comment parameters (e.g., a creator, a recipient, one or more followers, one or more other interested parties, content, one or more times, upvotes, other hard-coded responses, etc.), a project name, a project description, one or more project dates (e.g., a start date, a due date, a completion date, and/or other project dates), a status and/or progress (e.g., an update, a hardcoded status update, a measured status, quantity of units of work remaining in a given project, completed units of work in a given project, and/or other status parameter), one or more attachments, an associated URL, one or more interaction parameters (e.g., sources of the interactions, context of the interactions, content of the interactions, time for the interactions, and/or other interaction parameters), updates, ordering of units of work within the given project, hierarchical information (see, e.g., organization component 110), settings information (see, e.g., organization component 110), state of a workspace for a given task within the given project, and/or other information.

Portfolio information in portfolio records may define values of portfolio parameters for a portfolio managed within the collaboration environment. An individual portfolio may include one or more projects and/or one or more other portfolios. A project of a portfolio may be subordinate to the portfolio, make up the portfolio, and/or otherwise be organized within the heading of the portfolio. Portfolios may be presented to the users via portfolio pages of the collaboration environment to facilitate access to the portfolios. A portfolio page for a portfolio may comprise a user interface portion and/or dedicated user interface of the collaboration environment from which users access the portfolios.

The portfolio parameters may characterize portfolios managed within the collaboration environment and/or via the collaboration environment, and/or the metadata associated with the portfolios. Individual ones of the portfolios may be associated with individual ones of the portfolios records. The portfolio information may define values of the portfolio parameters associated with a given portfolio managed within the collaboration environment and/or via the collaboration environment. A given portfolio may have one or more owners and/or one or more collaborators working on the given portfolio. In some implementations, a given portfolio may not have any owners and/or collaborators at the portfolio level other than those specified with respect to the projects subordinate to the portfolio.

The values of the portfolio parameters may, by way of non-limiting example, include and/or specify one or more of: information about one or more projects within a given portfolio (which may include values of project parameters defined by one or more project records), information about one or more other portfolios within a given portfolio (which may include values of portfolio parameters defined by one or more other portfolio records), a portfolio name, a portfolio description, a status and/or progress (e.g., an update, a hardcoded status update, a measured status, quantity of units of work remaining in a given project, completed units of work in a given project, and/or other status parameter), one or more attachments, an associated URL, one or more interaction parameters (e.g., sources of the interactions, context of the interactions, content of the interactions, time for the interactions, and/or other interaction parameters), updates, ordering of projects within the given portfolio, hierarchical information (see, e.g., organization component 110), settings information (see, e.g., organization component 110), state of a workspace for a given project within the given portfolio, metadata associated with the portfolios, custom fields (e.g., values created by users), and/or other information.

The objective information in objective records may include values of one or more objective parameters. The values of the objective parameters may be organized in objective records corresponding to business objectives managed, created, and/or owned within the collaboration environment. A given business objective may have one or more collaborators, and/or team members working on the given business objective. Business objectives may include one or more associated units of work and/or projects one or more users should accomplish and/or plan on accomplishing. Business objectives may be created by a given user for the given user and/or created by the given user and assigned to be owned to one or more other users. Individual business objectives may include one or more of an individual goal, an individual sub-goal, and/or other business objectives assigned to be owned by a user and/or associated with one or more users.

The business objectives may be associated with a set of units of work and/or projects that may indirectly facilitate progress toward fulfillment of the business objectives. The set of units of work and/or projects may not directly contribute to the progress. By way of non-limiting illustration, a connection between the set of units of work and/or projects and a corresponding business objective may be indirect in that completion of at least one of the units of work and/or projects may have no direct impact on progress toward fulfillment of the business objective. The concept of “no direct impact” may mean that completion of the at least one unit of work and/or project may not cause progress toward fulfillment of the business objective without independent action outside of the at least one unit of work and/or project. Instead, the fulfillment of the at least one unit of work and/or project may make such independent action more likely (e.g., through coercion, assistance, education, incentivization, reminder, etc.). However, in some implementations, business objectives may be associated with a set of units of work and/or projects that may directly facilitate progress toward fulfillment of the business objectives. Accordingly, completion of the set of units of work and/or projects may directly contribute to the progress toward fulfillment. Business objectives may be associated with an objectives and key result (OKR) goal-setting framework. Business objectives may be specified on one or more of a team basis, organization basis, and/or other specifications. In some implementations, business objectives may be characterized as user objectives. The user objectives may be associated with a set of units of work and/or projects that may indirectly (and/or directly) facilitate progress toward fulfillment of the user objectives. User objectives may be specified on an individual user basis.

Individual objective records may describe individual business objectives and/or identify sets of individual ones of the work unit records and/or project records that specify the units of work and/or projects as being associated with the individual business objectives. Business objectives may be presented to the users via objective pages of the collaboration environment to facilitate access to the business objectives. An objective page for a business objective may comprise a user interface portion and/or dedicated user interface of the collaboration environment from which users access the business objective.

In some implementations, the one or more objective parameters may include one or more of an objective definition parameter, an objective owner parameter, an objective management parameter, an objective creation parameter, an objective progress parameter, and/or other parameters. The value of the objective definition parameter may describe the particular business objective. The values of the objective owner parameter may describe business objectives assigned to be owned by an individual user. The values of the objective management parameter may describe business objectives managed as collaborators by the individual users. The values of the objective creation parameter may describe business objectives created by the individual users.

In some implementations, the business objectives may be described based on one or more of a business objective name, a business objective description, one or more business objective dates (e.g., a start date, a due date, and/or dates), one or more users associated with a business objective, progress information (e.g., an update, a hardcoded status update, a measured status, a progress indicator, quantity value remaining for a given business objective, completed work units in a given project, and/or other progress information), one or more interaction parameters, notification settings, administrative settings, privacy, an associated URL, one or more custom fields (e.g., priority, cost, stage, and/or other custom fields), and/or other information.

The values of the objective owner parameter describing business objectives owned by the individual users may be determined based on one or more interactions by one or more users with a collaboration environment. In some implementations, one or more users may create and/or assign ownership of one or more business objectives to themselves and/or another user. In some implementations, a user may be assigned to own a business objective and the user may effectuate a reassignment of ownership of the business objective from the user or one or more other users.

The organization component 110 may be configured to obtain hierarchical information specifying hierarchies of records. In some implementations, the hierarchical information may specify work unit hierarchies. A work unit hierarchy may convey individual positions of work unit records (and their corresponding units of work) in a record hierarchy comprising solely work unit records. By way of non-limiting illustration, a position may specify one or more of a work unit record being superior to one or more other work unit records, a work unit record being subordinate to one or more other work unit records, and/or other information. As a result, individual work units of work in the individual sets of work unit records may be subordinate to other individual work unit records in the individual sets of work unit records. For example, a work unit record may define a unit of work comprising a task, and a subordinate work unit record may define a unit of work comprising a sub-task to the task. A record hierarchy may define a relationship between work unit records. A work unit record may have some restrictions placed on it by virtue of having a subordinate work unit record, and vice versa. By way of non-limiting illustration, a work unit record may be restricted from access by one or more users unless and/or until a subordinate work unit record is completed and/or started.

In some implementations, the hierarchical information may specify project hierarchies. A project hierarchy may convey individual positions of project records (and their corresponding projects) in a record hierarchy comprising solely project records.

In some implementations, the hierarchical information may specify portfolio hierarchies. A portfolio hierarchy may convey individual positions of portfolio records (and their corresponding portfolios) in a record hierarchy comprising solely portfolio records.

In some implementations, the hierarchical information may specify objective record hierarchies. Individual sets of objective records may be defined by an objective record hierarchy. An objective record hierarchy may convey individual positions of objective records (and their corresponding business objectives) in the objective record hierarchy.

In some implementations, the hierarchical information may specify multi-record hierarchies. A multi-record hierarchy may convey individual positions of different types of records within a record hierarchy. By way of non-limiting illustration, multi-record hierarchy may convey individual positions of work unit records, project records, portfolio records, objective records, and/or other records in a record hierarchy comprising one or more of work unit records, project records, portfolio records, objective records, and/or other records. By way of non-limiting illustration, the hierarchical information may specify that individual work unit records are subordinate to individual project records. The hierarchical information may specify that individual project records are subordinate to individual portfolio records. By way of non-limiting illustration, an individual project record may include one or more work unit records by virtue of the one or more work unit records being subordinate to the individual project record. An individual portfolio record may include one or more project records by virtue of the one or more project records being subordinate to the individual portfolio record.

In some implementations, hierarchical information may specify multi-homed hierarchical information. The multi-homed hierarchical information may specify that individual records are concurrently subordinate to more than one other record. This may be referred to as multi-homing. By way of non-limiting illustration, a first work unit record may be subordinate to a first project record and a second project record.

The organization component 110 may be configured to obtain settings information for individual records. Settings information may include values of parameters that define and/or dictate one or more settings associated with the individual records. In some implementations, the settings may include one or more of notification settings, presentation settings, access settings, and/or other settings.

Notification settings may be related to who and/or in what manner notifications related to records are sent. In some implementations, notification settings may be specified by one or more values of one or more notification parameters of the records. In some implementations, notification parameters may characterize one or more of who notifications are sent to, the content of the notifications, the frequency of sending the notifications, one or more triggers for sending notifications, and/or other considerations.

Presentation settings may be related to how information in a given record (e.g., the values of parameters) is presented within a user interface of the collaboration environment. In some implementations, presentation settings may be specified by one or more values of one or more presentation parameters of the records. How information is presented may refer to the form and/or format of the presentation of the values of parameters that make up the records. Form may refer to the expression of the values. Form may include one or more of font (of text), resolution (e.g., in graphics, images, etc.), short or long form presentation, one or more value-specific forms, and/or other considerations. By way of non-limiting illustration, value-specific forms of a value for a due date parameter may include one or more “mm/dd/yyyy”; “yyyy/mm/dd”; Month Day, Year, and/or other forms. By way of non-limiting illustration, value-specific forms of a value for a date range parameter may include one or more daily, weekly, monthly, quarterly, yearly, and/or other formats. By way of non-limiting illustration, value-specific forms of a value for a user name parameter may include one or more “‘first name’ ‘last name’”; “‘last name’, ‘first name’”; “‘first name’ ‘first letter of last name’”; and/or other forms. Format may refer to the organization or arrangement of the values. Format may include one or more of location of presentation within a page, accessibility on page, and/or other considerations.

Access settings may be related to user access to individual records. In some implementations, access settings may be specified by one or more values of one or more access parameters of the records. The access parameters may characterize access restrictions and/or permissions with respect to how users interact with individual records. By way of non-limiting illustration, access parameters of the individual work unit records may characterize access to one or more of the individual units of work, subordinate units of work, digital content items associated with the units of work, and/or other access characteristics. By way of non-limiting illustration, access parameters of the individual project records may characterize access to the individual projects and/or one or more of the work unit records that are subordinate to the individual project records. By way of non-limiting illustration, access parameters of the individual portfolio records may characterize access to one or more of the individual portfolios, one or more of the project records that are subordinate to the individual portfolio records, and/or one or more of the work unit records that are subordinate to the individual project records. In some implementations, access may be binary, including access being “granted” or access being “denied.” In some implementations, access may be characterized by ability to navigate to and/or from one or more records.

In some implementations, access restrictions with respect to how users interact with records may be characterized based on enabling and/or disabling one or more features. Individual features may be specific to individual records. The features related to the individual units of work may be specific to completing and/or supporting specific ones of the individual units of work. The features related to the individual projects may be specific to supporting the individual projects. The features related to the individual portfolios may be specific to supporting the individual projects that make up the individual portfolios (which may include the features specific to supporting the individual projects), supporting the individual units of work that make up the projects (which may include the features specific to supporting the individual units of work), and/or other interactions. In some implementations, if one or more features are not enabled for a given user, those one or more features may be deemed disabled for the given user.

In some implementations, features specific to completing and/or supporting the individual units of work may include one or more of accessing individual work unit pages for the individual units of work, specifying completion status of the individual units of work, communicating with other users linked within the individual units of work, generating meetings with the other users linked within the individual units of work, accessing application programs outside of the collaboration environment, editing the individual units of work, and/or other features.

In some implementations, specifying completion status of the individual units of work may include the ability to change values of the work assignment parameter to indicate a unit of work has changed from “incomplete” to “marked complete” and/or “complete”. In some implementations, specifying completion status of the individual units of work may include the ability to change values of the work assignment parameter to indicate a unit of work has changed from “complete” or “marked complete” to “incomplete”.

In some implementations, communicating with other users linked within the individual units of work may include communicating within individual work unit pages (e.g., adding comments, messages, and/or other communications), communicating within the collaboration environment (e.g., messaging system not tied to a given unit of work), communicating outside of the collaboration environment (e.g., email, SMS, etc.), and/or other considerations.

In some implementations, generating meetings with other users linked to the individual units of work may include sending invites to the other users. Sending invites may include selecting meeting participants, proposed date/time for the meeting, setting agenda topics, and/or other functionality. Meeting generation may be facilitated by functionality that is integral to the collaboration environment and/or provided through access to an external resource (e.g., third party meeting generation applications).

In some implementations, editing the individual units of work may include one or more of adding, removing, changing, updating, and/or otherwise interacting directly with values of one or more work unit parameters of the individual units of work.

In some implementations, features specific to completing and/or supporting the individual projects may be enabled within individual project pages providing access to the individual projects. The individual sets of features specific to supporting the individual projects may include one or more of accessing the individual project pages, communicating with the other users within the individual projects, generating meetings with the other users, editing the individual projects, editing the units of work within the individual projects, and/or other features.

In some implementations, communicating with the other users within the individual projects may include communicating within individual project pages (e.g., adding comments, messages, and/or other communications), communicating within the collaboration environment (e.g., messaging system not tied to a given project), communicating outside of the collaboration environment (e.g., email, SMS, etc.), and/or other considerations.

In some implementations, communicating with the other users linked to the units of work within the individual projects may include communicating within individual work unit pages (e.g., adding comments, messages, and/or other communications), communicating within the collaboration environment (e.g., messaging system not tied to a given unit of work), communicating outside of the collaboration environment (e.g., email, SMS, etc.), and/or other considerations.

In some implementations, generating meetings with the other users linked within the individual projects may include sending invites to the other users. Sending invites may include selecting meeting participants, proposed date/time for the meeting, setting agenda topics, and/or other functionality.

In some implementations, generating meetings with the other users linked to the units of work within the individual projects may include sending invites to the other users. Sending invites may include selecting meeting participants, proposed date/time for the meeting, setting agenda topics, and/or other functionality. In some implementations, generating meetings with other users may be limited to other users having some linking to one or more of the units of work that make up the project.

In some implementations, editing the individual projects may include one or more of adding, removing, changing, updating, and/or otherwise interacting directly with values of one or more project parameters of the individual projects.

In some implementations, editing the units of work within the individual projects may include one or more of adding, removing, changing, updating, and/or otherwise interacting directly with values of one or more work unit parameters of the individual units of work within the project.

The conflict component 112 may be configured to identify conflicts between records. In some implementations, the settings for individual records that are subordinate to other individual records may be impacted by the settings of the other individual records. For example, the values of one or more parameters of an individual superior record may impact the values of the one or more parameters of the subordinate records. Because of this, conflicts between one or more of the values may be created when a given record is specified as subordinate to more than one other record.

In some implementations, the settings for individual units of work that are subordinate to an individual project may be impacted by the settings of the individual project. For example, the values of the access parameters of an individual project record may impact the values of the access parameters of one or more of the unit of work records that may be subordinate to the individual project record. Because of this, conflicts between values of the access parameters may be created when a work unit record is specified as subordinate to more than one other record. In some implementations, the settings available for an individual project that is subordinate to an individual portfolio record may be impacted by the settings of the individual portfolio record. For example, the values of the access parameters of the individual portfolio record may impact the values of the access parameters of the individual project. Because of this, conflicts between values of the access parameters may be created when a project record is specified as subordinate to more than one other record.

By way of non-limiting illustration, conflict component 112 may be configured to identify conflicts between the individual work unit records and individual project records by virtue of the individual work unit records being subordinate to more than one of the project records. By way of non-limiting illustration, a first conflict in the first work unit record may be identified. The first conflict may be between the first project record and the second project record by virtue of the first work unit record being subordinate to both the first project record and the second project record. That is, both the first project record and the second project record may be attempting to impact values of parameters of the first work unit record. The impact may be conflicting causing the first conflict to exist.

In some implementations, the conflicts may be related to how the information in the records should be presented in a user interface of the collaboration environment (e.g., values of presentation parameters). By way of non-limiting illustration, conflict with regards to work unit information being presented may include a conflict in the form of how due dates should be presented. By way of non-limiting illustration, the first project record may dictate that its subordinate units of work include dates in the form of “mm/dd/yyyy”, while the second project record may dictate that its subordinate units of work include dates in the form of “Month Day, Year.” Accordingly, this poses a conflict in how to present due dates in the first unit of work given that it is subordinate to both of these records.

In some implementations, the conflicts may be related to access restrictions to the records (e.g., values of access parameters). By way of non-limiting illustration, the first project record may dictate that only a given team of users can access the units of work that are subordinate to the first project record; while the second project record may dictate that the units of work are open for public inspection from all users. Accordingly, this poses a conflict in how to grant access to the first unit of work given that it is subordinate to both records.

In some implementations, the conflicts may be related to notifications related to the records (e.g., values of notification parameters). By way of non-limiting illustration, the first project record may dictate that a project manager is notified when a subordinate unit of work is added to the first project; while the second project record may dictate that an assignor of a subordinate unit of work is notified when the subordinate unit of work is added to the second project. Accordingly, this poses a conflict in how to send notifications in relation to the first unit of work given that it is subordinate to both of these records.

In some implementations, identifying the conflicts between records may be based on determining impact of one or more records on other ones of the records. The impact component 114 may be configured to determine the impact by looking at the impact of the values of one or more parameters of a given record (e.g., superior record) on the values of the one or more parameters of an other record (e.g., a subordinate record). In some implementations, impact may be characterized by one or more of causing a change to the values, having no impact on the values, and/or other considerations. In some implementations, when a given subordinate record is multi-homed in more than one other superior record, a conflict may be identified when it is determined that the other superior records have different and/or conflicting impacts on the given subordinate record. By way of non-limiting illustration, impact component 114 may be configured to identify conflicts between the individual work unit records and the individual project records in response to the project values of the more than one project record impacting the work unit values of individual work unit records in a conflicting manner.

By way of non-limiting illustration, impact component 114 may be configured to determine one or more of a first impact of a first project value of the first project record on a first work unit value of the first work unit record, a second impact of a second project value of the second project record on the first work unit value of the first work unit record, and/or other impacts. The first conflict may be identified responsive to the first impact being conflicting to the second impact. By way of non-limiting illustration, the first project value, the first work unit value, and the second project value may be values for one or more of notification parameters, presentation parameters, access parameters, and/or other parameters. The first project value and the first work unit value may be the same value. Therefore, the first impact may be “no impact.” The second project value may be different from the first work unit value such that the second project value may dictate that the first work unit value should change. Accordingly, the first conflict is identified.

By way of non-limiting illustration, the first project value, the first work unit value, and the second project value may be values for a presentation parameter. The first project value may dictate that dates are presented in “mm/dd/yyyy” form; the first work unit value may dictate that dates are presented in “mm/dd/yyyy” form; and the second project value may dictate that dates are presented in “yyyy/mm/dd” form. The first project value does not impact the first work unit value; while the second project value conflicts with the form dictated by the first project value.

By way of non-limiting illustration, the first project value, the first work unit value, and the second project value may be values for an access parameter. The first project value may dictate that only a given team of users can access units of work within the first project; the first work unit value may dictate that any user can access the first unit of work; and the second project value may dictate that any user can access units of work within the second project. The first project value impacts the first work unit value by causing it to change to a stricter form of access; while the second project value does not impact the first work unit value but conflicts with the first project value because it is less restrictive.

The resolution component 118 may be configured to resolve conflicts between the records. The resolution component 118 may be configured to resolve conflicts between the individual work unit records and the individual project records. The resolution component 118 may be configured to resolve conflicts between the individual work unit records and the individual portfolio records. The resolution component 118 may be configured to resolve conflicts between the individual project records and the individual portfolio records. The resolution component 118 may be configured to resolve conflicts between the individual project records and other the individual project records. By way of non-limiting illustration, resolution component 118 may be configured to resolve the first conflict.

In some implementations, resolving the conflicts may comprise only allowing one or more superior records to impact a given subordinate record, while suppressing the impact of other superior records on the given subordinate record. By way of non-limiting illustration, resolving conflicts may comprise only allowing project values from one project record to impact the work unit values of a work unit record when the work unit record is subordinate to the more than one project record. By way of non-limiting illustration, resolving the first conflict may include only allowing the first project value of the first project record to have the first impact on the first work unit value of the first work unit record, and suppressing the second impact.

The rules component 116 may be configured to determine which one of multiple records should impact a given record when the given record is subordinate to the multiple records and a conflict exists. In some implementations, the determination may be based on one or more rules.

By way of non-limiting illustration, the rules component 116 may be configured to determine, based on one or more rules, which project record should impact work unit values of an individual work unit record when the individual work unit record is subordinate to the more than one project record. By way of non-limiting illustration, one or more rules may dictate that the first project record should proceed with the first impact on the first work unit value of the first work unit record and the second impact should be suppressed.

In some implementations, one or more rules governing which record should have an impact and which record(s) should be suppressed may be automatic as the rules may be pre-configured. By way of non-limiting illustration, a pre-configured rule may be, for conflicts in values of access parameters, that the record that has the most restrictive access should have impact and the record with the lesser restrictive access should be suppressed. This rule may ensure that no confidential and/or secure information is inadvertently presented because the system 100 will cause the most restrictive settings to win out.

In some implementations, one or more rules governing which record should have impact and which should be suppressed may be configured manually as conflicts arise. By way of non-limiting illustration, when a conflict arises, one or more users may be notified to resolve the conflict. This may involve user provided input as to which record should win out in this particular conflict. This may be recorded as a rule that is carried out when similar conflicts arise in connection to records linked to that user. In some implementations, one or more rules may be specified ahead of time by a user. By way of non-limiting illustration, the user may have a superior role to other collaborators of project records and/or work unit records. The user may have a managerial position where the user specifies the baseline rules for resolving conflicts between records when conflicts arise. By way of non-limiting illustration, a user may specify ahead of time that the record that does not impact a subordinate record wins out, while other records that may act to change how the subordinate record is already specified may be suppressed. This may help to maintain the settings that are closest to the lowest level of work in a hierarchy (e.g., the units of work). Alternatively, a user may specify ahead of time that a superior record that does impact a subordinate record wins out, while other superior records that do not change the subordinate record may be suppressed.

In some implementations, the environment state component 108 may be configured to obtain requests to access individual pages of individual records. By way of non-limiting illustration, the environment state component 108 may be configured to obtain requests to access individual work unit pages of the individual units of work. By way of non-limiting illustration, the environment state component 108 may be configured to obtain requests to access individual project pages of the individual projects. By way of non-limiting illustration, the environment state component 108 may be configured to obtain requests to access individual portfolio pages of the individual portfolio. By way of non-limiting illustration, the environment state component 108 may be configured to obtain requests to access individual objective pages of the individual business objectives.

In some implementations, in response to the environment state component 108 obtaining the requests to access the individual pages of the individual records, the resolution component 118 may be configured to determine whether any conflicts associated with the individual records whose pages are being requested have been resolved. In some implementations, in response to the resolution component 118 determining the conflicts have been resolved, the environment state component 108 may provide access to the individual pages. In some implementations, in response to the resolution component 118 determining the conflicts have not been resolved, the environment state component 108 may deny access to the individual pages.

In some implementations, in response to determining the conflicts have not been resolved, resolution component 118 may be configured to generate and/or deliver a notification to a computing platform associated with a user linked to one or more of the records involved in the conflict. In some implementations, the notification may include a prompt to resolve the conflict, to contact another user to resolve the conflict, and/or other information. A user may provide input into the notification.

In some implementations, environment state information may be updated as users continue to interact with the collaboration environment via the user interfaces over time. The environment state component 108 may store and/or archive the environment state information periodically and/or based on user request to archive. In some implementations, the environment state component 108 may store historical environment state information specifying historical user information, historical work information, historical project information, historical portfolio information, historical objective information, user interaction history, historical hierarchy information, and/or other information.

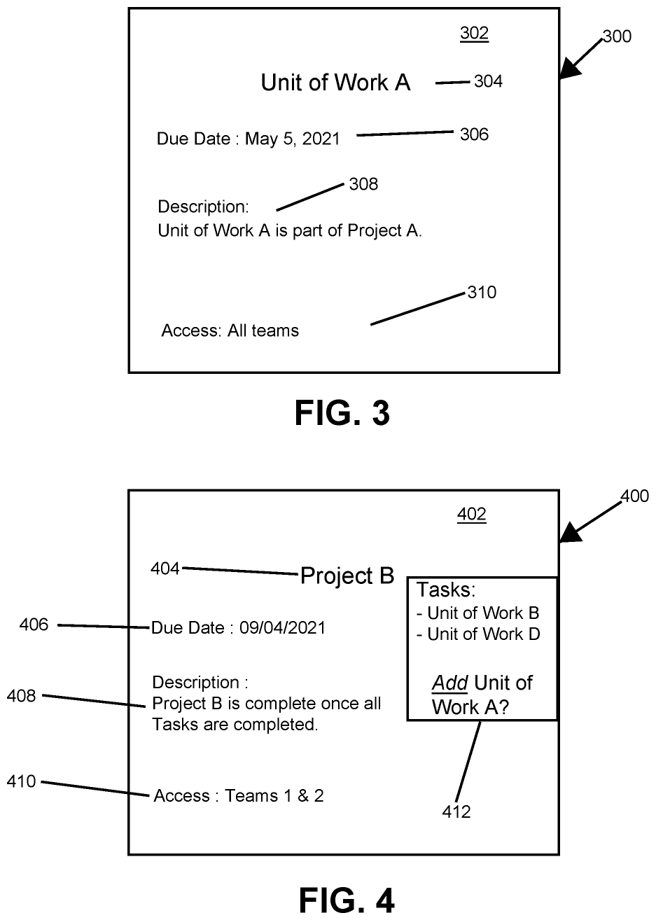

FIG. 3 illustrates a user interface 300 of a collaboration environment, in accordance with one or more implementations. The user interface 300 may illustrate a work unit page 302 of a unit of work 304. For illustrative purpose, the unit of work 304 may be referred to as “Unit of Work A,” and may be subordinate to a Project C. The work unit page 302 may present information included in the work unit record of the unit of work 304 including one or more of a due date 306, a description 308, access settings 310, and/or other information. In some implementations, the due date 306 may be presented in a first form (e.g., “Month Day, Year”). The access settings 310 may include that “All teams” can access the work unit page 302.

FIG. 4 illustrates a user interface 400 of a collaboration environment, in accordance with one or more implementations. The user interface 400 may illustrate a project page 402 of a project 404. The project page 402 may present information included in a project record of the project 404 including one or more of a due date 406, a description 408, access settings 410, list 412 of units of work included in project 404, and/or other information. In some implementations, the due date 306 may be presented in a second form (e.g., “mm/dd/yyy”). The access settings 310 may include that “Teams 1 and 2” can access project page 402 and/or the units of work included in the project 404. The list 412 of units of work may include an option to add the Unit of Work A (FIG. 3) to the project 404.

In response to adding Unit of Work A to project 404, conflict between one or more settings may arise. Project B and Project A may be both attempting to impact the values of one or more parameters of Unit of Work A. By way of non-limiting illustration, a first conflict may be related to the form of presenting due dates (e.g., the first form as already applied to Unit of Work A via Project A, and the second form as dictated by Project B). By way of non-limiting illustration, a second conflict may be related to the access restriction (e.g., Project A dictating less restrictions—All teams, and Project B dictating more restrictions—Teams 1 and 2).

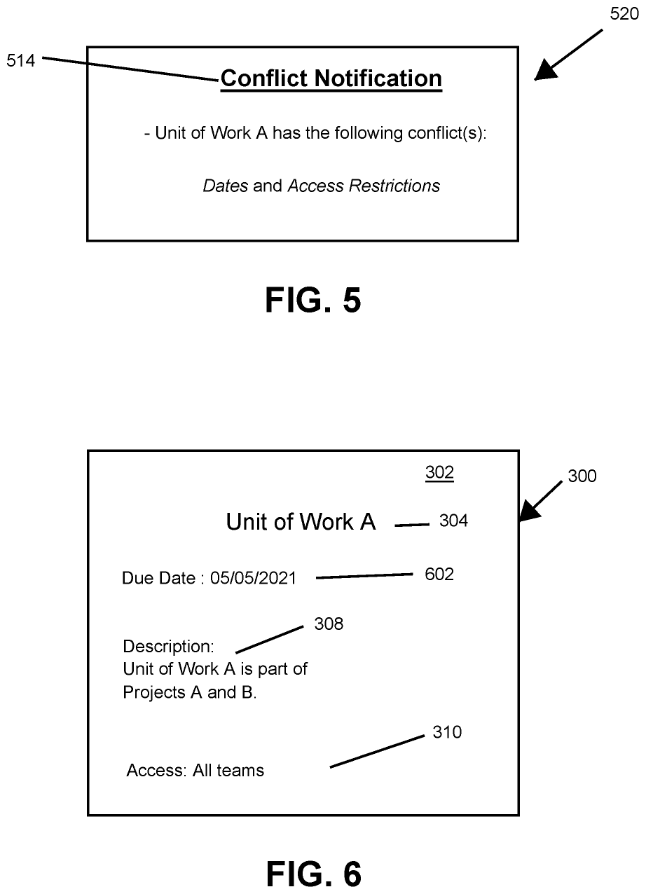

FIG. 5 illustrates a user interface 520 of a collaboration environment, in accordance with one or more implementations. The user interface 520 may illustrate conflict notification 514 presented in response to identifying one or more conflicts in Unit of Work A by virtue of being subordinate to both Project A and Project B. However, in some implementations, one or more rules may be in place to automatically resolve the conflicts without prompting the presentation of the conflict notification 514.

FIG. 6 illustrates the user interface 300 of FIG. 3 illustrating the work unit page 302 in response to resolving one or more conflicts. For illustrative purposes, the work unit page 302 may include one or more of an updated due date 602, the same access settings 310, and/or other information. In this example, resolving the first conflict included allowing the second form of due date presentation to win out; and resolving the second conflict included proceeding with the less restrictive access settings (e.g., no impact to the original settings of Unit of Work A).

Referring back to FIG. 1, in some implementations, server(s) 102, client computing platform(s) 104, and/or external resource(s) 126 may be operatively linked via one or more electronic communication links. For example, such electronic communication links may be established, at least in part, via a network 117 such as the Internet and/or other networks. It will be appreciated that this is not intended to be limiting, and that the scope of this disclosure includes implementations in which server(s) 102, client computing platform(s) 104, and/or external resource(s) 126 may be operatively linked via some other communication media.

A given client computing platform may include one or more processors configured to execute computer program components. The computer program components may be configured to enable an expert or user associated with the given client computing platform to interface with system 100 and/or external resource(s) 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resource(s) 126 may include sources of information outside of system 100, external entities participating with system 100, and/or other resources. In some implementations, some or all of the functionality attributed herein to external resource(s) 126 may be provided by resources included in system 100.

Server(s) 102 may include electronic storage 128, one or more processors 130, and/or other components. Server(s) 102 may include communication lines, or ports to enable the exchange of information with a network 117 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, a physical processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, 118 and/or other components. Processor(s) 130 may be configured to execute components 108, 110, 112, 114, 116, 118 and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, and/or 118 are illustrated in FIG. 1 as being implemented within a single processing unit, in implementations in which processor(s) 130 includes multiple processing units, one or more of components 108, 110, 112, 114, 116, and/or 118 may be implemented remotely from the other components. The description of the functionality provided by the different components 108, 110, 112, 114, 116, and/or 118 described below is for illustrative purposes, and is not intended to be limiting, as any of components 108, 110, and/or 112 may provide more or less functionality than is described. For example, one or more of components 108, 110, 112, 114, 116, and/or 118 may be eliminated, and some or all of its functionality may be provided by other ones of components 108, 110, 112, 114, 116, and/or 118. As another example, processor(s) 130 may be configured to execute one or more additional components that may perform some or all of the functionality attributed below to one of components 108, 110, 112, 114, 116, and/or 118.

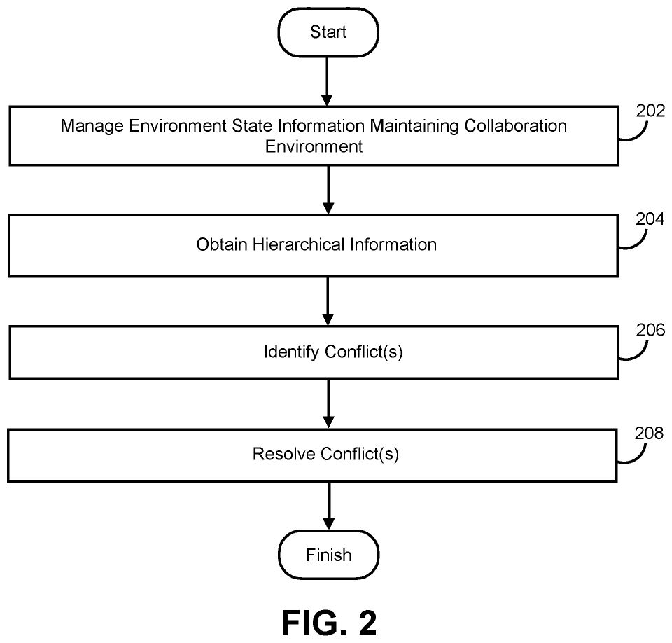

FIG. 2 illustrates a method 200 to resolve conflicts between records of a collaboration environment, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a collaboration environment. The collaboration environment may be configured to facilitate interaction by users with the collaboration environment. The environment state information may include one or more of work unit records, project records, and/or other records. The work unit records may include work unit information associated with units of work managed, created, and/or assigned within the collaboration environment, and/or other information. The project records may include project information associated with projects managed, created, and/or assigned within the collaboration environment, and/or other information. Operation 202 may be performed by one or more hardware processors configured by machine-readable instructions including a component that is the same as or similar to environment state component 108 (shown in FIG. 1 and described herein), in accordance with one or more implementations.

An operation 204 may obtain hierarchical information for the work unit records, the project records, and/or other records. The hierarchical information may specify individual work unit records as subordinate to one or more of the project records. By way of non-limiting illustration, an individual project record may include one or more work unit records by virtue of the one or more work unit records being subordinate to the individual project record. By way of non-limiting illustration, a first work unit record may be subordinate to a first project record and a first project record. Operation 204 may be performed by one or more hardware processors configured by machine-readable instructions including a component that is the same as or similar to organization component 110 (shown in FIG. 1 and described herein), in accordance with one or more implementations.

An operation 206 may identify conflicts between the individual work unit records and individual project records by virtue of the individual work unit records being subordinate to more than one of the project records. By way of non-limiting illustration, a first conflict between the first work unit record and the first project record, and the first work unit record and the second project record is identified by virtue of the first work unit record being subordinate to both the first project record and the second project record. Operation 206 may be performed by one or more hardware processors configured by machine-readable instructions including a component that is the same as or similar to conflict component 112 (shown in FIG. 1 and described herein), in accordance with one or more implementations.

An operation 208 may resolve the conflicts between the individual work unit records and the individual project records. By way of non-limiting illustration, the first conflict may be resolved. Operation 208 may be performed by one or more hardware processors configured by machine-readable instructions including a component that is the same as or similar to resolution component 118 (shown in FIG. 1 and described herein), in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A system configured to resolve configuration setting conflicts between electronic records of a collaboration environment, the system comprising:
non-transitory electronic storage storing:
environment state information maintaining a collaboration environment, the collaboration environment being configured to facilitate interaction by users with the collaboration environment, the environment state information including work unit records and project records, the work unit records including work unit information associated with units of work managed, created, and/or assigned within the collaboration environment, the project records including project information associated with projects managed, created, and/or assigned within the collaboration environment;
hierarchical information specifying hierarchies for the work unit records and the project records, the hierarchical information specifying individual work unit records as subordinate to one or more of the project records, such that an individual project record is associated with one or more of the work unit records by virtue of the one or more of the work unit records being subordinate to the individual project record; and
settings information defining configuration settings of the work unit records, wherein the configuration settings dictate i) how the work unit information of the individual work unit records will be presented in individual work unit pages of the individual work unit records within a graphical user interface of the collaboration environment, and ii) restrictions on access to the individual work unit pages of the individual work unit records when navigating through the graphical user interface of the collaboration environment, wherein the configuration settings of individual subordinate work unit records are impacted by individual superior project records, wherein a first work unit record is subordinate to a first project record and a second project record, and wherein a set of configuration settings for the first work unit record are impacted by both the first project record and the second project record; and
one or more physical processors configured by machine-readable instructions to:
manage, by a server, the environment state information maintaining the collaboration environment;
identify, by the server by accessing the non-transitory electronic storage, the individual work unit records that have the configuration settings impacted by more than one superior project record, such that the first work unit record is identified by virtue of the set of configuration settings for the first work unit record being impacted by both the first project record and the second project record which results from the first work unit record being subordinate to both the first project record and the second project record;
identify, by the server, presence of configuration setting conflicts between the individual work unit records and individual project records that arise from the configuration settings of the individual work unit records being impacted by more than one superior project record, such that for the first work unit record, identify a first configuration setting conflict arising from the set of configuration settings for the first work unit record being impacted by both the first project record and the second project record, wherein the first configuration setting conflict is related to how the work unit information of the first work unit record will be presented in a first work unit page of the first work unit record within the graphical user interface of the collaboration environment, or restrictions on access to the first work unit page of the first work unit record when navigating through the graphical user interface of the collaboration environment; and
resolve, by the server, the configuration setting conflicts between the individual work unit records and the individual project records by adjusting the configuration settings of the individual work unit records stored in the non-transitory electronic storage so that the configuration settings of the individual work unit records are impacted by an individual superior project record instead of more than one superior project record, such that the first configuration setting conflict is resolved by adjusting the set of configuration settings of the first work unit record so that the set of configuration settings is impacted by either the first project record or the second project record.

2. (canceled)

3. (canceled)

4. The system of claim 1, wherein the work unit information includes work unit values of work unit parameters, and the project information includes project values of project parameters, and wherein the one or more physical processors are further configured by the machine-readable instructions to:
determine impact of the project values on the work unit values when the individual work unit records are subordinate to more than one superior project record, including determining a first impact of a first project value of the first project record on a first work unit value of the first work unit record, and a second impact of a second project value of the second project record on the first work unit value of the first work unit record; and
identify the configuration setting conflicts between the individual work unit records and the individual project records in response to the project values of more than one superior project record impacting the work unit values of the individual work unit records in a conflicting manner, such that the first configuration setting conflict is identified responsive to the first impact conflicting with the second impact.

5. The system of claim 4, wherein the impact is characterized by either causing a change to the work unit values or having no impact on the work unit values.

6. The system of claim 4, wherein resolving the configuration setting conflicts comprising only allowing the project values from one of the project records to impact the work unit values when the individual work unit records are subordinate to the more than one superior project record, such that resolving the first configuration setting conflict includes only allowing the first project value of the first project record to have the first impact on the first work unit value of the first work unit record, and suppressing the second impact.

7. The system of claim 6, wherein the one or more physical processors are further configured by the machine-readable instructions to:
determine which one of the project records should impact the work unit values when the individual work unit records are subordinate to more than one superior project record based on one or more rules, such that the first project value of the first project record is determined to have the first impact on the first work unit value of the first work unit record and the second impact is determined to be suppressed based on the one or more rules.

8. The system of claim 7, wherein the one or more rules are specified by a user.

9. The system of claim 1, wherein the one or more physical processors are further configured by the machine-readable instructions to:
obtain requests to access the individual work unit pages of the individual work unit records;
in response to obtaining the requests to access the individual work unit pages, determining whether the configuration setting conflicts have been resolved;
in response to determining the configuration setting conflicts have been resolved, provide access to the individual work unit pages; and
in response to determining the configuration setting conflicts have not been resolved, deny access to the individual work unit pages.

10. The system of claim 9, wherein the one or more physical processors are further configured by the machine-readable instructions to:
in response to determining the configuration setting conflicts have not been resolved, generate and deliver a notification to a computing platform associated with a user linked to one or more of the first work unit record, the first project record, or the second project record.

11. A method to resolve configuration setting conflicts between electronic records of a collaboration environment, the method comprising:
managing, by a server via non-transitory electronic storage, electronically stored environment state information maintaining a collaboration environment, the collaboration environment being configured to facilitate interaction by users with the collaboration environment, the environment state information including work unit records and project records, the work unit records including work unit information associated with units of work managed, created, and/or assigned within the collaboration environment, the project records including project information associated with projects managed, created, and/or assigned within the collaboration environment;
obtaining, by the server, electronically stored hierarchical information specifying hierarchies for the work unit records and the project records, the hierarchical information specifying individual work unit records as subordinate to one or more of the project records, such that an individual project record is associated with one or more of the work unit records by virtue of the one or more of the work unit records being subordinate to the individual project record;
obtaining, by the server, electronically stored settings information defining configuration settings of the work unit records, wherein the configuration settings dictate i) how the work unit information of the individual work unit records will be presented in individual work unit pages of the individual work unit records within a graphical user interface of the collaboration environment, and ii) restrictions on access to the individual work unit pages of the individual work unit records when navigating through the graphical user interface of the collaboration environment, wherein the configuration settings of individual subordinate work unit records are impacted by individual superior project records, wherein a first work unit record is subordinate to a first project record and a second project record, and wherein a set of configuration settings for the first work unit record are impacted by both the first project record and the second project record;
identifying, by the server by accessing the non-transitory electronic storage, the individual work unit records that have the configuration settings impacted by more than one superior project record, including identifying the first work unit record by virtue of the set of configuration settings for the first work unit record being impacted by both the first project record and the second project record which results from the first work unit record being subordinate to both the first project record and the second project record;
identifying, by the server, presence of configuration setting conflicts between the individual work unit records and individual project records that arise from the configuration settings of the individual work unit records being impacted by more than one superior project record, including identifying, for the first work unit record, a first configuration setting conflict arising from the set of configuration settings for the first work unit record being impacted by both the first project record and the second project record, wherein the first configuration setting conflict is related to how the work unit information of the first work unit record will be presented in a first work unit page of the first work unit record within the graphical user interface of the collaboration environment, or restrictions on access to the first work unit page of the first work unit record when navigating through the graphical user interface of the collaboration environment; and
resolving, by the server, the configuration setting conflicts between the individual work unit records and the individual project records by adjusting the configuration settings of the individual work unit records stored in the non-transitory electronic storage so that the configuration settings of the individual work unit records are impacted by an individual superior project record instead of more than one superior project record, including resolving the first configuration setting conflict by adjusting the set of configuration settings of the first work unit record so that the set of configuration settings is impacted by either the first project record or the second project record.

12. (canceled)

13. (canceled)

14. The method of claim 11, wherein the work unit information includes work unit values of work unit parameters, and the project information includes project values of project parameters, and wherein the method further comprises:
determining impact of the project values on the work unit values when the individual work unit records are subordinate to more than one superior project record, including determining a first impact of a first project value of the first project record on a first work unit value of the first work unit record, and a second impact of a second project value of the second project record on the first work unit value of the first work unit record; and
identifying the configuration setting conflicts between the individual work unit records and the individual project records in response to the project values of more than one superior project record impacting the work unit values of the individual work unit records in a conflicting manner, including identifying the first configuration setting conflict responsive to the first impact conflicting with the second impact.

15. The method of claim 14, wherein the impact is characterized by either causing a change to the work unit values or having no impact on the work unit values.

16. The method of claim 14, wherein resolving the configuration setting conflicts comprising only allowing the project values from one of the project records to impact the work unit values when the individual work unit records are subordinate to more than one superior project record, such that resolving the first configuration setting conflict includes only allowing the first project value of the first project record to have the first impact on the first work unit value of the first work unit record, and suppressing the second impact.

17. The method of claim 16, further comprising:
determining which one of the project records should impact the work unit values when the individual work unit records are subordinate to more than one superior project record based on one or more rules, including determining the first project value of the first project record is to have the first impact on the first work unit value of the first work unit record and the second impact is to be suppressed based on the one or more rules.

18. The method of claim 17, wherein the one or more rules are specified by a user.

19. The method of claim 11, further comprising:
obtaining requests to access the individual work unit pages of the individual work unit records;
in response to obtaining the requests to access the individual work unit pages, determining whether the configuration setting conflicts have been resolved;
in response to determining the configuration setting conflicts have been resolved, provide access to the individual work unit pages; and
in response to determining the configuration setting conflicts have not been resolved, deny access to the individual work unit pages.

20. The method of claim 19, further comprising:
in response to determining the configuration setting conflicts have not been resolved, generate and deliver a notification to a computing platform associated with a user linked to one or more of the first work unit record, the first project record, or the second project record.
